(19) United States
(12) Patent Application Publication
(10) Pub. No.: US 2004/0060998 A1
(43) Pub. Date: Apr. 1, 2004

(54) Fluid control valve

(76) Inventors: Wolfgang Stoecklein, Stuttgart (DE); Dietmar Schmieder, Markgroeningen (DE)

Correspondence Address: Ronald E Greigg, Greigg & Greigg, 1423 Powhatan Street, Unit One, Alexandria, VA, 22314, US

(21) Appl. No.: 10/276,689

(22) PCT Filed: Mar. 24, 2001
(86) PCT No.: PCT/DE01/01161

(30) Foreign Application Priority Data
May 16, 2000 (DE) 100 28 952.8

(51) Int. Cl. F02M 41/16

(52) U.S. Cl. 239/102.2; 239/584; 239/96; 239/533.9; 239/600

(57) ABSTRACT

The present invention relates to a valve for controlling fluids, which includes a valve member (4) that is actuatable via a piezoelectric actuator (2) and a hydraulic booster (3). The valve further includes a holder (6), a valve piece (7), a shim (8), and a nozzle body (9). The valve piece (7), the shim (8), and the nozzle body (9) are joined together via at least two screws (13), and the screws (13) are disposed radially to a center axis (M-M) of the valve. This makes both a simple design of the valve and economical assembly possible.

### PRIOR ART

The present invention relates to a valve for controlling fluids as generically defined by the preamble to claim 1.

Valves for controlling fluids are known in the most various embodiments. For instance, in FIGS. 3 and 4, a valve for controlling fluids is shown which has a valve member 4 that is actuatable via a piezoelectric actuator 2 and a hydraulic booster 3. The valve further includes a holder 6, a valve piece 7, a shim 8, and a nozzle body 9. As shown in FIG. 3, the hydraulic booster here is disposed partly in the holder 6, in the valve piece 7 and the shim 8 offset from a center axis M-M of the valve. The hydraulic booster 3 furthermore has a first seat 11 and a second seat 12. A cylinder of the hydraulic booster is disposed in a body 23. As also visible in FIG. 3, the piezoelectric actuator 2 is disposed offset from the center line M-M. The individual parts of the valve 1, that is, the holder 6, valve piece 7, shim 8 and nozzle body 9, are secured to one another by a nozzle lock nut 10. The nozzle lock nut 10, in its lower region, has a thread which is screwed into a thread provided on the holder 6.

To assure reliable functioning of the valve 1, the individual parts 6, 7, 8, 9 must each have a precise positional orientation to one another. Therefore before the nozzle lock nut 10 is put in place, the holder 6 and the valve piece 7 are joined together by two alignment pins. The valve piece 7 and the shim 8 are likewise joined together with an alignment pin. To enable centering the individual parts by means of the nozzle lock nut 10, respective centering rings 7a, 8a, as shown in FIG. 7, are provided on the valve piece 7 and on the shim 8 for radially centering these parts. Their angular position relative to one another is thus assured by the radial centering by the nozzle lock nut 10 (see FIG. 4), in order particularly at the first seat 11 and the second seat 12 to obtain a very precise radial orientation. The shim 8 and the nozzle body 9 are moreover also joined together by means of two alignment pins. After that, the individual parts are braced against one another by the nozzle lock nut 10.

However, this assembly of the individual parts is very complicated and quite expensive. Moreover, major variations or warping when the nozzle lock nut 10 is tightened can cause imprecise radial centering, particularly between the valve piece 7 and the shim 8. Also, because of the nozzle lock nut, the piezoelectric actuator 2 must be installed eccentrically from the center line M-M.

### ADVANTAGES OF THE INVENTION

The valve for controlling fluids of the invention having the characteristics of the main claim has the advantage over the prior art that a nozzle lock nut for bracing the individual parts can be dispensed with. The valve piece, the shim, and the nozzle body are joined to one another by at least two screws. The screws are disposed radially to the center axis of the valve. This makes a central disposition of the piezoelectric element also possible. In comparison with the prior art, the body disposed in the holder, for receiving part of the hydraulic booster, can be integrated with the valve piece, making it possible to reduce the number of component parts. Moreover, good radial centering of the shim relative to the valve piece is furnished, without requiring additional machining operations on the two individual parts. As a result, the angular tolerance between injection ports and clamping faces of the holder is also reduced. Moreover, the valve of the invention makes it possible to furnish a larger installation space for the valve member, making an optimal disposition of the valve member possible. Also in comparison with the nozzle lock nut of the prior art, the screws can be secured with greater tightening forces, without adverse effects on the positional precision of the individual parts of the valve.

In a preferred feature of the present invention, the holder as well is joined to the valve piece, the shim and the nozzle body via the screws.

In another advantageous feature of the invention, the holder is joined to the valve piece by means of welding. The result particularly in the holder is a larger installation space for the individual parts of the valve to be received therein. Moreover, screws with a larger diameter can also be used. As a result, a greater prestressing force can be exerted by the screws, and the number of screws can be reduced.

Advantageously, the piezoelectric actuator is disposed centrally in the valve. This makes for an especially simple design of the valve of the invention.

Advantageously, the hydraulic booster is also disposed centrally in the valve. In particular, this makes it possible to simplify the radial orientation between the first and the second seat.

To enable a concealed disposition of the head of the screw, a recess is preferably provided in the nozzle body, or in the holder, or in the valve piece.

A disk is advantageously provided for radially sealing off the nozzle body from the motor.

### DRAWING

Two exemplary embodiments of the invention are shown in the drawing and will be explained in further detail in the ensuing description.

FIG. 1 shows a valve for controlling fluids in a first exemplary embodiment of the present invention;

FIG. 2 shows a valve for controlling fluids in a second exemplary embodiment of the present invention;

FIG. 3 shows a valve for controlling fluids in accordance with the prior art; and

FIG. 4 shows an enlarged view of a detail of the valve shown in FIG. 3.

### DESCRIPTION OF THE EXEMPLARY EMBODIMENTS

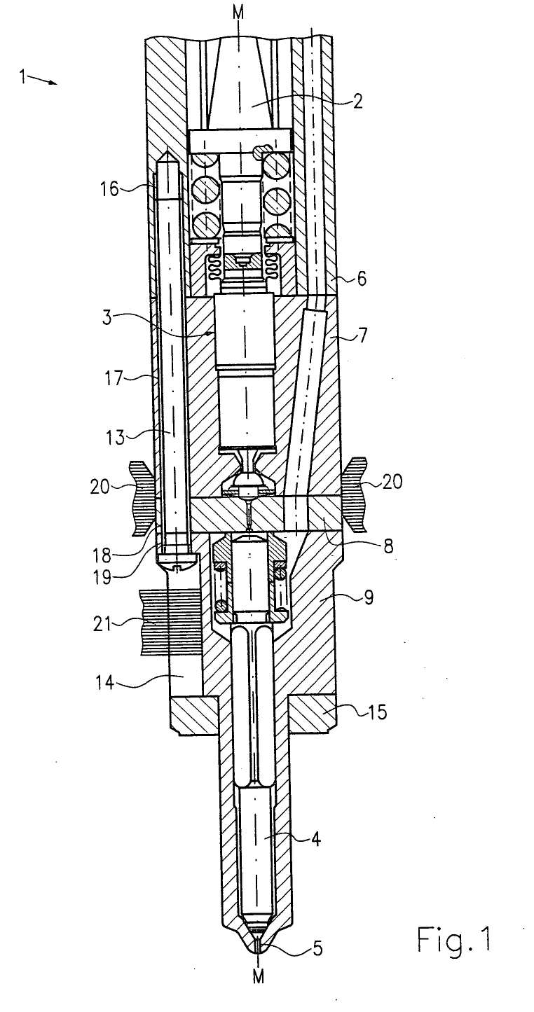

In FIG. 1, a first exemplary embodiment of a valve for controlling fluids of the present invention is shown.

As shown in FIG. 1, the valve 1 includes a valve member 4, which is actuatable via both a piezoelectric actuator 2 and a hydraulic booster 3. The valve member 4 closes and opens an inlet opening 5, through which fuel is delivered to a combustion chamber.

As shown in FIG. 1, the valve 1 includes a holder 6, a valve piece 7, a shim 8, and a nozzle body 9 in which the valve member 4 is disposed. The holder 6, valve piece 7, shim 8 and nozzle body 9 are joined together by two screws 13. For the sake of clearer illustration of the valve 1, only one screw 13 is shown in FIG. 1. More precisely, a threaded bore 16 is provided in the holder 6, a threaded bore 17 is provided in the valve piece 7, a threaded bore 18 is provided in the adapter 8, and a threaded bore 19 is provided in the nozzle body 9, each bore receiving the screw 13.

To make it easier to screw the screw 13 in, a recess 14 which is covered by a disk 15 is provided on the nozzle body 9.

As shown in FIG. 1, both the piezoelectric actuator 2 and the hydraulic booster 3 are disposed centrally on a center line M-M of the valve 1. The result is a simpler design of the valve 1 of the invention, and there is more room for disposing fuel supply lines, for instance, or other devices of the valve.

In FIG. 1, two centering tools 20 and 21 are also shown, which are used in assembling the valve 1. The valve piece 7 is centered radially to the shim 8 by means of the centering tool 20. The angular position of the nozzle body 9 relative to the holder 6 is also set by the centering tool 21. Next, the screws 13 are introduced and tightened. Thus the design of the valve according to the invention also makes fast, economical assembly possible, without using expensive alignment pins.

As shown in FIG. 1, in the present exemplary embodiment, the screw 13 is introduced in the direction of the holder 6, beginning at the nozzle body 9. However, it is also conceivable for the screw 13 to be introduced beginning at the holder 6 toward the nozzle body 9. In that case, corresponding recesses would have to be provided on the holder 6.

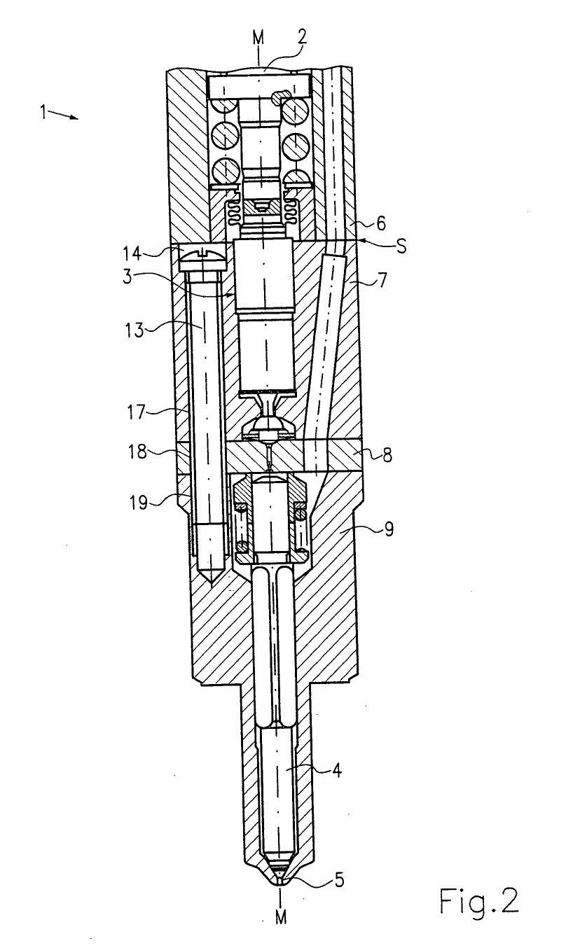

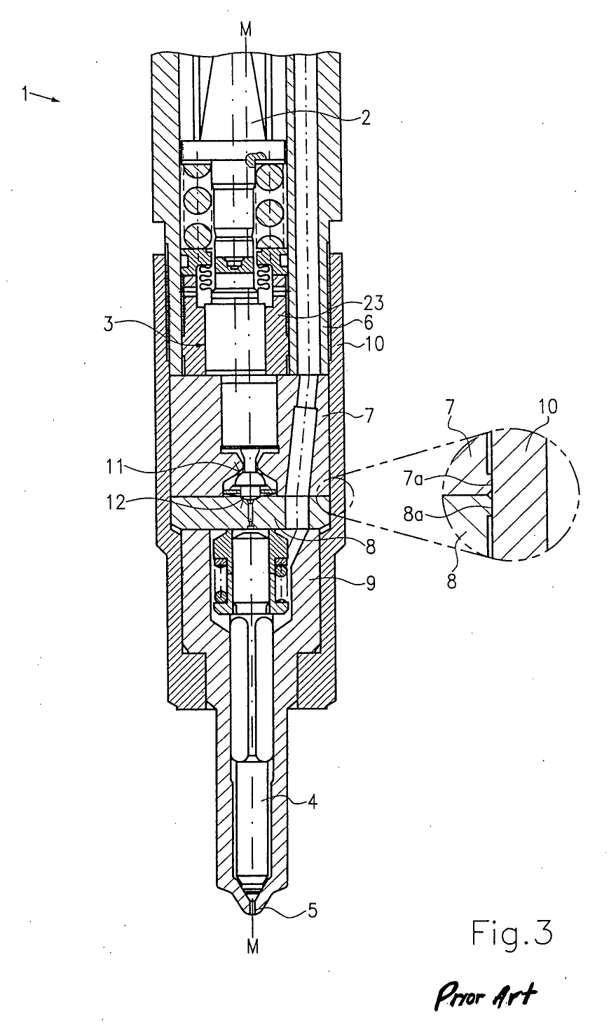

In FIG. 2, a second exemplary embodiment of a valve for controlling fluids in accordance with the present invention is shown. Identical elements are identified by the same reference numerals as in the first exemplary embodiment.

As shown in FIG. 2, the valve 1 again includes a holder 6, a valve piece 7, a shim 8, and a nozzle body 9. Unlike the first exemplary embodiment, however, in the second exemplary embodiment only the valve piece 7, shim 8 and nozzle body 9 are joined together by screws 13. As in the first exemplary embodiment, in FIG. 2 as well only one screw 13 is shown. The screw 13 is introduced from the side of the valve piece 7 oriented toward the holder 6, and it is guided by a threaded bore 17 in the valve piece 7, a threaded bore 18 in the shim 8, and a threaded blind bore 19 in the nozzle body 9. The head of the screw 13 is sunken in a recess 14 formed in the valve piece 7. Thus the screws 13 assure the critical positional orientation of the valve piece 7 relative to the shim 8 and to the nozzle body 9.

The valve piece 7 is joined to the holder 6 by means of a weld S. However, a connection can also be made by screw means, or by screwing means and additional welding. Thus upon the assembly of the valve 1 in the second exemplary embodiment, first the valve piece 7, shim 8, and nozzle body 9 are joined together via the screws 13, and then the valve piece 7 is welded to the holder 6. This makes it possible to use screws 13 of a larger diameter. As a result, a greater prestressing force can be exerted, and the number of screws can be reduced. Moreover, the relatively complicated machining of the nozzle body 9 to produce the recess 19 can be dispensed with, as can the disk 15 for covering the screw 13. In the second exemplary embodiment, as shown in FIG. 2, the screw 13 is covered by the holder 6.

In summary, to this point, a valve for controlling fluids has been described which includes a valve member 4 that is actuatable via a piezoelectric actuator 2 and a hydraulic booster 3. The valve also includes a holder 6, a valve piece 7, a shim 8, and a nozzle body 9. The valve piece 7, shim 8, and nozzle body 9 are joined together via at least two screws 13, and the screws 13 are disposed radially to a center axis M-M of the valve. This makes both a simple design of the valve and economical assembly possible.

The above description of the exemplary embodiments of the present invention is intended solely for illustrative purposes and not for the sake of limiting the invention. Within the scope of the invention, various changes and modifications may be made without departing from the scope of the invention or its equivalents.

1. A valve for controlling fluids, [by means of] having a valve member (4) controlling an inlet opening (5)
a holder (6)
a valve piece (7)
a shim (8) and
a nozzle body (9),
characterized in that the valve member [(5)] (4) is disposed in the nozzle body (9), a hydraulic booster is disposed in the valve piece (7), and a shim (8) is disposed between the nozzle body and the valve piece, and the valve member is actuated by a piezoelectric actuator via the hydraulic booster in the valve piece, the piezoelectric actuator and the hydraulic booster being disposed centrally to the center axis of the valve, and the nozzle body (9), the shim and the valve piece are joined to one another via at least two screws (13) disposed radially to a center axis (M-M) of the valve.

2. The valve for controlling fluids of claim 1, characterized in that the valve piece (7), shim (8) and holder (6) are joined together by screws (13).

3. The valve for controlling fluids of claim 1, characterized in that the holder (6) is joined to the valve piece (7) by means of welding.

4. The valve for controlling fluids of one of claims 1-3, characterized in that a recess (14) for receiving a head of the screw (13) is provided.

5. The valve for controlling fluids of one of claims 1-4, characterized in that a disk (20) is also provided, for covering the screw (13).
